(19) United States
(12) Patent Application Publication
(10) Pub. No.: US 2016/0125563 A1
(43) Pub. Date: May 5, 2016

(54) System and Method for Smart Passenger and Freight Transportation

(71) Applicant: Joseph Lai, San Pedro, CA (US)

(72) Inventor: Joseph Lai, San Pedro, CA (US)

(21) Appl. No.: 14/530,804

(22) Filed: Nov. 2, 2014

(51) Int. Cl. G06Q 50/30; G06Q 50/28; G06Q 10/06

(52) U.S. Cl. CPC G06Q 50/30; G06Q 10/06311; G06Q 10/063112; G06Q 50/28

(57) ABSTRACT

A smart passenger and freight transportation system which is fast, flexible, reliable, low-cost, energy efficient and environmentally friendly for freight and passenger to be picked up, carried, forwarded, relayed and delivered by regular travelers using the payload capacities of transportation equipment they already use for traveling on land, over the water, or in the air. This smart transportation system will be managed by service providers who designate the location of stations for receiving, storing, and forwarding items; compute and calculate the routes and fees; and maintain telecommunication networks for dispatching available, regular and qualified travelers to be in the right place at the right time to drop-off, pick up and transport the passenger and freight from source to destination. This smart transportation system can be a relief or backup system for our existing passenger and freight transportation systems or vice versa.

### CROSS-REFERENCES

This application incorporates by reference the U.S. Pat. No. 6,285,878 in its entirety. Joseph Lai is the sole inventor of the U.S. Pat. No. 6,285,878 and the invention is disclosed in this application.

### FIELD OF THE INVENTION

This present invention is related to a smart, modern and better way of transporting passengers and freight, or other non-electronically deliverable items by all travelers with assistance of phones and computer applications of the telecommunication network.

### BACKGROUND OF THE INVENTION

Why is this invention necessary?

### The Problems

Our current transportation systems are very old; very expensive, extremely inefficient with tremendous resources are totally wasted with thanks to lack of resource planning, gathering, sharing, managing, consolidating and system control. Our current transportation system relies almost entirely on burning fossil fuels; it is not only very expensive but also terribly hurting our environment. For cost, sometimes the transportation cost is much more than the items we are transported. And to make thing worse and add the cost, for passengers and freight, and/or any physical items, transportation is normally done by expensive dedicated professional agencies or companies. In the United States, freight is delivered by US Postal Services, UPS, FedEx and other agencies, using expensive employees and equipment on a non 24/7 basis. Passengers are professionally delivered by airlines, trains, and buses which are also operated by expensive professional service providers with expensive employees.

The worst part is there are millions of independent travelers with their own transportation equipment also on the road, over the water and in the air who consumes tremendous more of fuels and polluting even more of our environment. Typical car weights 3000 to 5000 lbs carries only the driver weighs less than 200 lb, indeed the worst of waste of mankind for energy, time, money, resources plus also killing our environment.

Car/van pooling system is nothing new which is a great idea of sharing but it is mostly only for transporting passengers/commuters going to or coming back from work in a local community. These car pool services was never extended to a larger scale and never create a better way of national or international networks for managing of transporting passengers plus freight.

### The Solution

No doubt individual and independent travelers have the excessive of capability of transporting items more than what they normally do right now. The solution is to build a smart transportation system based on these travelers and computer technologies and telecommunication infrastructure available to gather information of the capability and availability of independent travelers, managing the supply and demand, affording them the opportunity to utilize their excess capacities to deliver passenger and freight.

10 or 20 years ago this present solution won't be possible because of lack of Internet access and poor coverage of the wireless infrastructural for cellular phone but after Billion of dollars was invested by phone companies, this present invention is finally ready as the most useful application of cellular network with smartphone for the solution of the new Smart passenger and freight transportation system.

### SUMMARY OF THE INVENTION

Our telecommunication systems (deliver digital data) have changed a lot but our transportation system has not. Conventional passenger and freight transportation systems can be improved if the average traveler takes advantage of their excessive capability of transportation, with many advantages such as:
Faster transportation, as large quantities of travelers can join and greatly increase available transportation
Easier, as many service provider locations can be easily setup as stations with travelers everywhere can be notified for pickup, transport and delivery
The stations provided nearby can develop more business as the travelers need gas, food, service
Less expensive, since our transportation system is a by-product of existing travelers who have to travel
Available 24/7/365, as travelers are going various places at anytime, all the time but the professionals are not
Very efficient, since no dedicated travelers are required and it is not necessary for traveler to stop-by all Hubs as normal professional driver does
Environmentally friendly, energy efficient, clean up the SMOG in the air we breath, reduces the carbon foot print and slow down global warming
Reduces tremendous traffic congestions on road, highway or freeway
Makes a profit for participated travelers and service providers
Can work together with existing systems as a relief or backup system
Better security and privacy as shippers or recipients can go to automated or manned stations to pickup or drop-off their packages. For traveler, it is also less likely to get robbed or hijacked as travelers' transportation equipment won't be noticeable compare to the professionals always with company logo on their truck. And even when that happened; the loss is much minimal by the traveler than the professional with the whole Big truck load of valuables are gone.
Travelers are more possibly could act as good Samaritan of helping and taking care other travelers in case of emergency, accident or any other troubles while they travel

### BRIEF DESCRIPTION OF THE DRAWINGS

FIG. 1. Conventional transportation systems with hubs (Prior Art)

FIG. 2. Detailed map for “last and first” mile of transportation

FIG. 3. Presents the transportation system with combined hubs and hubless delivery

FIG. 4. Presents the transportation system with totally hubless delivery

FIG. 5. Flowchart of present system from requesting service to receiving the item

FIG. 6. Flowchart of recommended system delivery from stations to stations

### DETAILED DESCRIPTION

Imitating how the computer and telecommunication data network delivers “packet switched data” as in a packet switching data network, this present invention delivers “passengers and freight” as packets of data in the existing network of all transportation means by travelers.

The invented transportation system consists of these following:
Freight

Freight, cargo or package/parcel comes in all sizes, shapes, weights, and values, with consideration needed for environment, timing, perishability, hazardousness, legality, sensitivity, security and all other issues, considering there are a lot of freight is very heavy, bulky but does not have good values.
Passengers

Delivering passengers is much more complicated than freight. A seat, food, water, toilet, AC/heater, and even medicine have to be accommodated.
Freight containers

Standard size re-usable, durable containers with electronic or mechanical locks are preferred.
Drop-off & pickup stations

These stations would preferably be located near the populated business area such as gas stations, convenient stores, drug stores, supermarkets, roadside rest area, fast food restaurant, shopping centers with plenty of parking spaces and not far from where traveler parks, docks or landed. In case of emergency, traveler can meet wherever they want to for drop-off, pickup the items. Typical stations are very low cost to operate, can be franchised, piggybacked or whole owned and managed by any business.
Management of the stations

The stations can be either manned or can be automated warehouse to receive, store and forward passengers and freight
Travelers

Travelers can be either professional or non-professional. Non-professional, non-dedicated travelers are pre-qualified and trained. They can be belonging to certain member of shopping, automobile, traveling or special interest clubs. They just happen to go routinely or randomly from places to places, have the access to transportation equipment and can pickup and deliver the freight or passenger(s) according to the instructions. Travelers are indemnified of the liability and safety with the content of the freight.
Transportation equipment

By feet/legs, bicycle, motorcycle, car, truck, bus, train, boat, and airplane; anything and whatever traveler can access to for transportation means.
Managing computers, server and on-line website access

The computer manages the data base of shippers, travelers and station information. When a shipper has freight to ship from an available station, the computer will locate and notifying available travelers. One selected will pick up and forward the freight. Shipper and recipient can track the location of the freight through the computer system.
Shippers

Shipper is the owner of the freight or the passenger, shipper brings freight (or himself) to the station, find appropriate container, seal it, store it and wait for traveler to pick it up and deliver it to the destination station or final recipient's place.
Telecommunication Infrastructural

Wireless network is preferred, and must cover the range of the traveler's route. GPS equipped smart phones with Apps can help keep track and report the location of the freight
Travelers' telecommunication equipment or PCD (Personal Communication Device)

Travelers must be equipped with cellular phones, good battery with data access and GPS (Global Positioning System) which can access the managing computer for pickup and delivery

Conventional passenger and freight transportation systems employ only dedicated professional drivers, sailors or pilots and dedicated transportation equipment to deliver freight. Our present invention is designed for non-professional travelers with whatever available transportation equipment available to deliver the freight and passenger. The computerized data base network will collect information on non-professional travelers and use cellular wireless technology to notify them to go to the stations for freight pickup and transportation it to the designated station (or address).

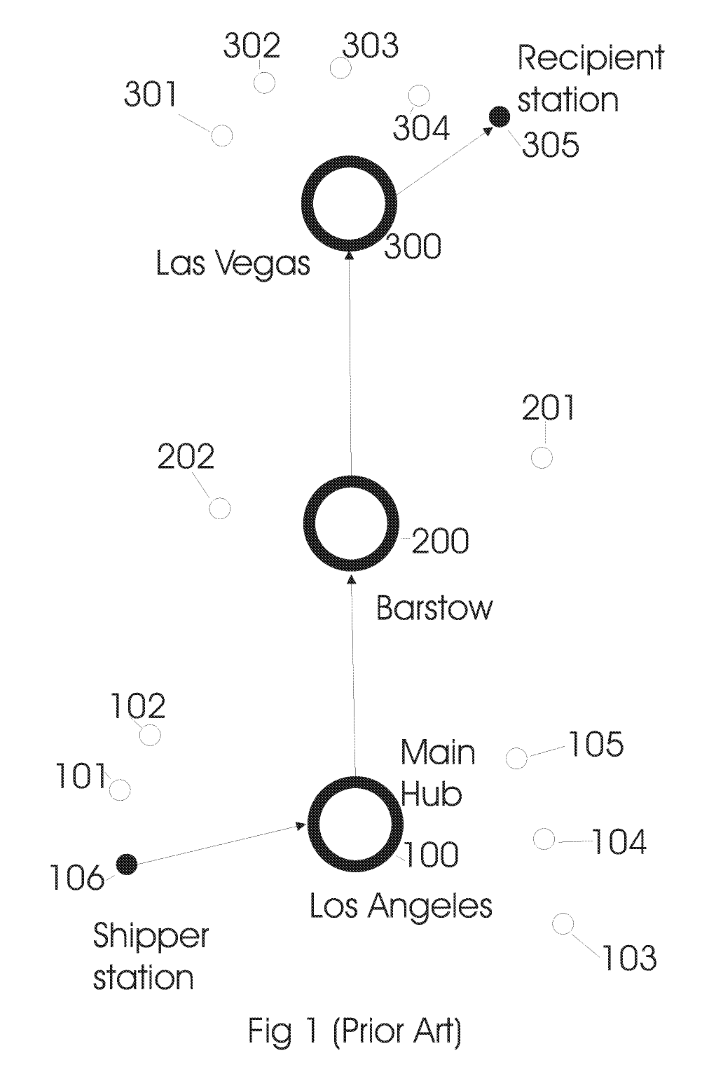

FIG. 1 shows how the prior art of conventional passengers and freight are transported via a “HUB” oriented system. For example, to transport items from Los Angeles to Las Vegas, freight owners and passengers are gathered at station (106) nearby. The freight then goes to a main “HUB” (100), then to Barstow HUB (200), then to Las Vegas HUB (300) and eventually reaches the final station at (305).

Notice the HUB'd system is very similar to the old fashion “circuit switched network” that phone companies were using for a hundred years until lately with the birth of Internet “packet switching”. The phone companies have a Central Office (CO) in the area. All the telephone wires are going from the subscriber to CO, and then go out to either another CO or to other local subscribers. Old fashion connecting is obsolete, as the cost is high and so vulnerable, since calls from neighbors have to go through CO, and once the CO is down, the whole system collapses.

Notice, from station (105) to station (201), conventional system would request the station (105) to go to main Hub (100) then go to Hub (200) then go to station (201). If there are travelers available between station (105) to station (201), there is no reason to go to two main Hubs, which save gas, time, road congestion without pollution of the air.

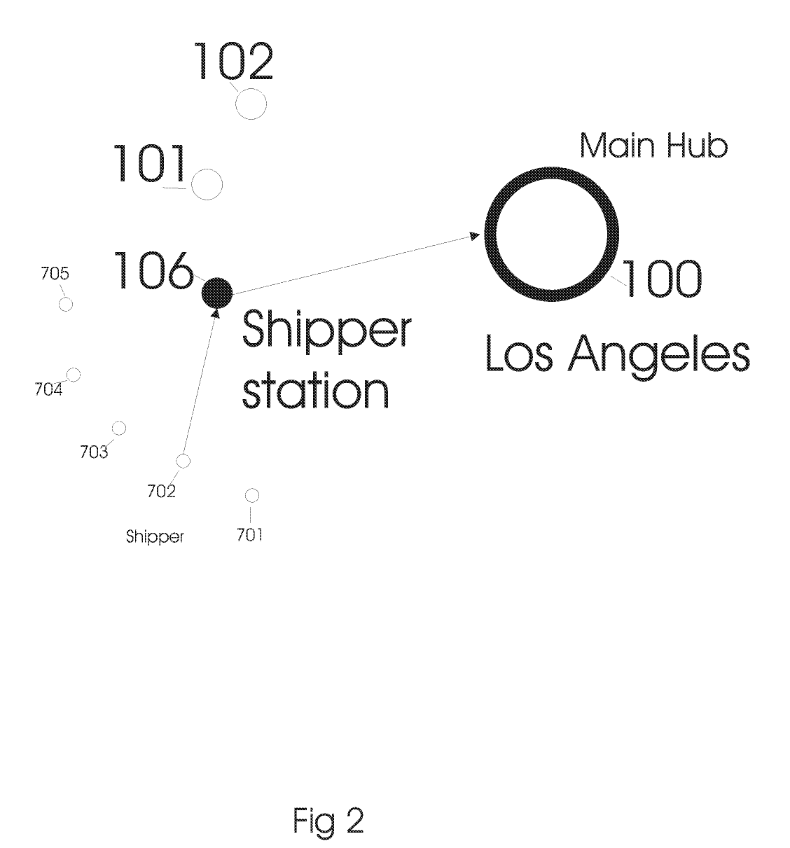

FIG. 2 shows the “last mile” of the invented system. The service request point of passengers or freight, (702) is the starting point of the journey. For example, in the prior art of shipping a package, we must go to the local station (106), such as a Postal Office or UPS. For passengers, we can go to a Bus station (106) and wait, and then the Bus takes the passengers to CO (100) such as the Los Angeles Airport (LAX). From that (100), they keep going by professional carrier, such as airlines to carry the item to the destination, and may or may not go through another city (transit).

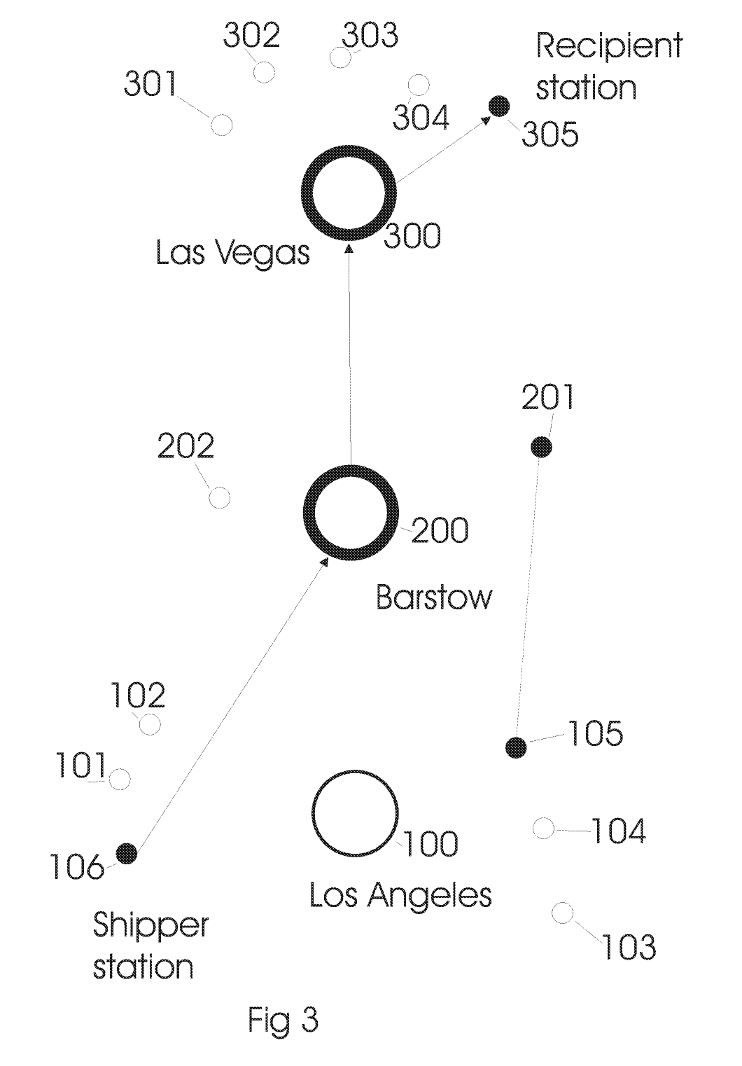

FIG. 3 shows the invented system, partially without some Hubs. Travelers are everywhere on the road, in the air or over the water at any time. Travelers are on stand-by for assignments of carrying passengers or freight at any time. Once the service request has arrived in the server of the computer, with the shipping information (such as the origin, destination, weight, etc.) the computer will search the database of nearby stations plus available travelers (or commuters). In the case of FIG. 3, the service request is a freight owner wanting to ship a package from Los Angeles to somewhere in Las Vegas, so the computer calculates the routes and locates the (106) station as the origin station and (305) station as the destination station. By search the data base of available travelers, computer finds a traveler going near (106) to (200) Barstow. The computer send out a wireless texting/email/voice message to Traveler A, notifying him/her to go to station (106) and pickup the package and deliver it to Barstow station (200). After the package has arrived to (200), the computer locates traveler B, who is going from Barstow to Las Vegas. The computer notifies Traveler B and he/she picks up the package at (200) Barstow station and delivers it to Las Vegas (300). Traveler C is also required for the last leg of pickup (300) and transportation to the recipient station (305) which is the destination station. At that station, computer can either notify the recipient to go to station (305) to pick it up or arrange another local Traveler D to pick it up and deliver the “last mile” to the recipient.

Interesting to mention this traveler based transportation network could be very flexible, in case of emergency, vehicle break down, traveler needs rest or accident or whatever reasons for traveler not be able to deliver, there are thousands of other travelers might be nearby, going to the same places, can offer some help. For the passenger or freight that is on route, the nearby traveler receives the stress call, stop and identify himself, makes the non-station emergency stop and pickup whatever as the replacement traveler and keep going and deliver the passenger and freight to the next station. Compares to the professional transportation services, if their truck broke down, the driver has to request for a backup truck. That backup truck can be hundred miles away and cost a good fortune for getting back to normal with much more shippers will be affected of the delayed service.

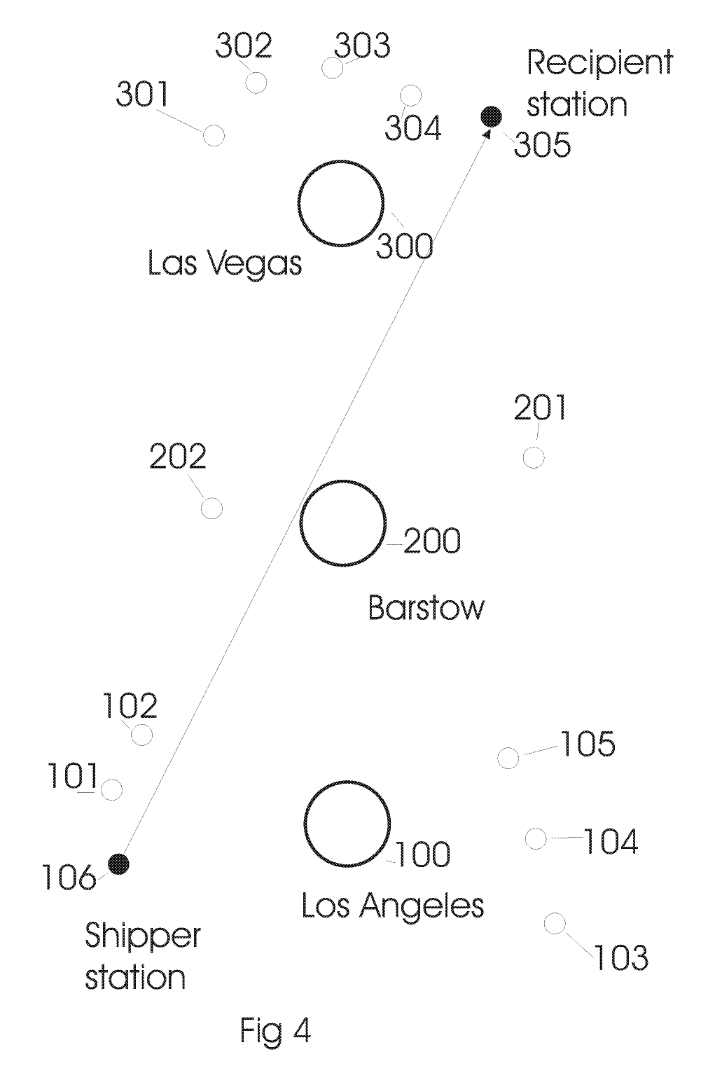

FIG. 4 has another example of direct transportation from station (106) to recipient station (305) without going through (100) Los Angeles station (200) Barstow station and (300) Las Vegas station. This could save tremendous time for transporting the freight compared to the UPS or FedEx we are using now.

There is not much added cost to this invented system. Travelers are going near station (106) then to (305) anyway. Typical automobile weight is 3,000-5,000 lb, so adding another 200 lb of freight would probably add less than 5% of the fuel consumption. This invented system is extremely useful to reduce the congestion of the traffic on the road and also saves tremendous energy, as cars are the worst pollutants of human beings.

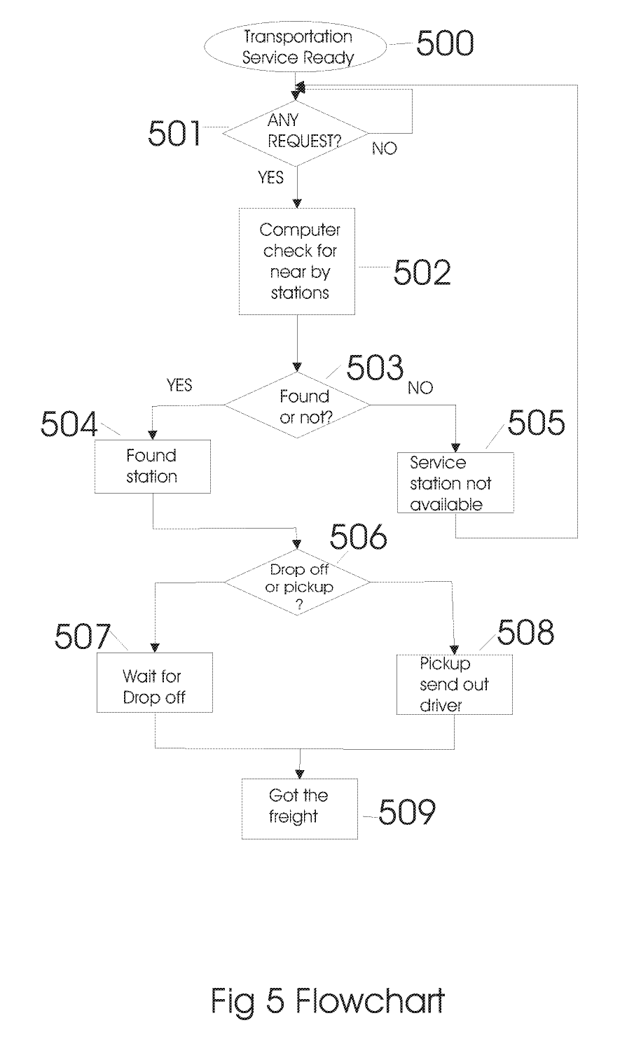

FIG. 5 shows the flowchart of how the centralized computer system works. For example, a shipper requests and initiates (500) a shipping service of a package from Los Angeles to Las Vegas. This request can be done electronically via an Internet website, verbally by phone, or by going to a station (106). After receiving the service request, computer will search and calculate (502) the best route from Los Angeles to Las Vegas, using its associated stations and available travelers. At (503) if a nearby station is found, the computer will ask the shipper to go to the station (106) and drop the package off (504). If not, the computer will tell the shipper the service is not available (505), either terminating the request or recommending the shipper go to professional couriers. At (506) if drop off is not possible, the computer will find a local traveler to go pick it up (508) and at (509) we have got our package at station (106).

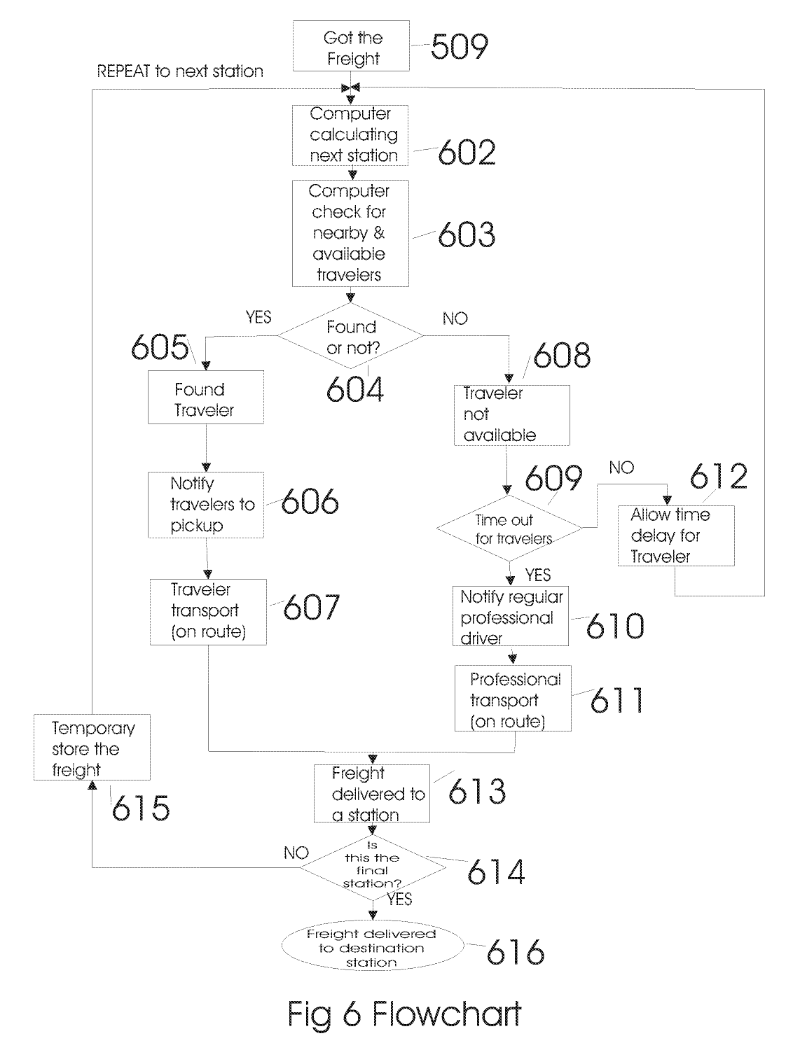

FIG. 6 shows the flowchart of how the software and hardware of the system works. At (509) the package is stored. Computer is searching its data base of associated stations and available travelers (602) (603). At (604) computer has found the station and the traveler (605). Computer will notify the traveler to pickup at the station (606). Once the traveler has the package, he/she is on-route (607) to the next station (613). On the other hand, at (604) if the computer can not find either a traveler or a station (608), computer will wait based on the urgency of the package transportation (608). If shipper is not in a hurry (609), wait until the allowed time expires (612) and go back to search again (602) until a traveler is available. If the package must be delivered in a hurry, the computer will notify (610) the professional courier to come to pickup the package and transport it to the next station (613). Once the package arrived at station (613) the computer will check (614) whether this is the final destination station. If it is, the package goes from station to stations. Otherwise, the package will be stored temporary (615) and computer will keep searching for the next traveler and next station (602) until the package is delivered at (616)

All stations can be either manned or automated for receiving, storing and forwarding the passenger or freight. Automation is the best way to reduce costs and add convenience for shippers, recipients and travelers.

### CONCLUSION

This invented smart transportation system is faster, very flexible, more reliable, more secure, very low cost, fuel efficient and environmentally friendly, reduces the congestion of our road traffic and makes profits for travelers. Like all the regular transportation systems or businesses, there could be risks. However, just as same as all current professional transportation services, all the participating stations and travelers are qualified and indemnified of liability and safety from the content of the freight. All freight can be insured. And overall, it is a great new smart infrastructure of transportation for non-electronically deliverable items. In short, this invention is the new network of supply and demand for a smart energy efficient, environmentally friendly transportation system before “teleporting” becomes available.

I claim:

1. A smart passenger and freight transportation system, comprising of:
(a) a plurality of stations to receive, store, forward said passenger and freight,
(b) a plurality of travelers have the capability of transporting said passenger and freight,
(c) computer equipment with networks of telecommunication means for routing and dispatching said travelers to carry the said passenger and freight from start location via said stations and delivers to final destinations,
(d) telecommunication equipment for said travelers of notifying and dispatching said travelers of pickup and deliver said passenger and freight and
Whereby said system delivers said passenger and said freight by said traveler with the assistance of said computer and telecommunication equipment.

2. The system of claim 1, where in said travelers are commuters or non-professional couriers but do traveling from locations to locations.

3. The system of claim 1, where in said travelers are available and qualified.

4. The system of claim 1, where in said stations are maintained by a centralized service provider with capability of receiving, storing and forwarding said passenger and freight.

5. The system of claim 4, where in said centralized service provider receives the request of transportation from said passenger and said freight owner and then calculating best routes for the available said stations and said available and qualified travelers.

6. The system of claim 1, where in said telecommunication equipment for said traveler is a two-way wireless or wired phones, smartphones, tablet PCs, computers.

7. The system of claim 1, where in said stations are at fixed, temporary or mobile locations within the coverage of telecommunication service.

8. The system of claim 1, where in said capability of transportation for said traveler is either a driver or as a passenger of transportation equipment.

9. The system of claim 1, where in said traveler is indemnified from the liability of the content of said freight.

10. The system of claim 1, where in said traveler is backed up by professional courier in case of lack of enough said stations and said non-professional travelers.

11. A method of smart passenger and freight transportation system, comprising of the steps of:
(a) providing a plurality of stations to receive, store, forward said passenger and freight,
(b) gathering a plurality of travelers have the capability of transporting said passenger and freight,
(c) providing computer equipment computer equipment with networks of telecommunication means for routing and dispatching said travelers to carry the said passenger and freight from start location via said stations and delivers to final destinations,
(d) providing telecommunication equipment for said travelers of notifying and dispatching said travelers of pickup and deliver said passenger and freight and
Whereby said method delivers said passenger and said freight by said traveler with the assistance of said computer and telecommunication equipment.

12. The method of claim 11, where in said travelers are commuters or non-professional couriers but do traveling from locations to locations.

13. The method of claim 11, where in said travelers are available and qualified.

14. The method of claim 11, where in said stations are maintained by a centralized service provider with capability of receiving, storing and forwarding said passenger and freight.

15. The method of claim 14, where in said centralized service provider receives the request of transportation from said passenger and said freight owner and then calculating best routes for the available said stations and said available and qualified travelers.

16. The method of claim 11, where in said telecommunication equipment for said traveler is a two-way wireless or wired phones, smartphones, tablet PCs, computers.

17. The method of claim 11, where in said stations are at fixed, temporary or mobile locations within the coverage of telecommunication service.

18. The method of claim 11, where in said capability of transportation for said traveler is either a driver or as a passenger of transportation equipment.

19. The method of claim 11, where in said traveler is indemnified from the liability of the content of said freight.

20. The method of claim 11, where in said traveler is backed up by professional courier in case of lack of enough said stations and said non-professional travelers.
